(19) United States
(12) Patent Application Publication
(10) Pub. No.: US 2013/0157073 A1
(43) Pub. Date: Jun. 20, 2013

(54) Bi-Metallic Component And Method

(71) Applicants: Pascal Paul Charest, Caledon East (CA); Gregor Leopold Babic, Brampton (CA); Peter Moonen, Clarksburg (CA); Eric Albertus deNijs, Toronto (CA)

(72) Inventors: Pascal Paul Charest, Caledon East (CA); Gregor Leopold Babic, Brampton (CA); Peter Moonen, Clarksburg (CA); Eric Albertus deNijs, Toronto (CA)

(21) Appl. No.: 13/701,904

(22) PCT Filed: Jun. 10, 2011
(86) PCT No.: PCT/CA11/50356

§ 371 Date: Mar. 2, 2013

Related U.S. Application Data
(60) Provisional application No. 61/353,304, filed on Jun. 10, 2010.

(51) Int. Cl. B32B 15/01; B22D 19/00; B32B 3/26

(52) U.S. Cl. CPC B32B 15/012; B32B 3/266; B22D 19/0081
USPC 428/596; 164/100; 164/76.1

(57) ABSTRACT

A bi-metallic component including a first member of a first metal and a second member of a second metal different than the first metal. The first member includes at least one perforation. The second member is directly cast-in-place about a sheet-like portion of the first member and through the perforation to rigidly secure the first and second members. When used in an automotive vehicle, the second metal of the second member is preferably of aluminum and the first metal of the first member is preferably a high strength steel for spot welding to other steel structures.

### CROSS REFERENCE TO RELATED APPLICATIONS

This U.S. National Stage patent application claims the benefit of International Patent Application Serial No. PCT/CA2011/050356 filed on Jun. 10, 2011, entitled “Bi-Metallic Component And Method,” and U.S. Provisional Application Ser. No. 61/353,304 filed Jun. 10, 2010, the entire disclosure of the applications being considered part of the disclosure of this application, and hereby incorporated by reference.

### BACKGROUND OF THE INVENTION

1. Field of the Invention

The present invention is related to a bi-metallic component. Specifically, the present invention is related to a bi-metallic component for an automobile.

2. Description of the Prior Art

There is a continuing need to decrease the weight of automobiles in order to improve both performance and fuel economy. One way to reduce the weight of a vehicle is to make the vehicle body of a light metal, such as aluminum, rather than steel. However, it may be very costly to use aluminum for the entire vehicle body because portions of the vehicle body may be subjected to very large forces, and a large amount of aluminum would be required to resist those forces. Therefore, it is desirable to produce a vehicle body which strategically includes portions made of steel to resist large forces and portions made of aluminum where increased strength is not necessary. In other words, it is desirable to optimize the cost of production and the weight of a vehicle body without compromising the vehicle body's resistance to failure.

The problem with manufacturing a vehicle body of both steel and aluminum is that welding these two materials together is extremely difficult. Spot welding is the preferred method of joining components of a vehicle body because spot welding is quick, efficient and produces a very strong connection. In the prior art, other fastening means, such as bolts, rivets or brazing, have been used to connect steel and aluminum components together. However, these fastening means may be too costly, time consuming, inefficient and/or prone to failure to be used in the manufacturing of a vehicle body. Therefore, many vehicle bodies are made entirely of steel so that the various components of the vehicle body can be spot welded together. Additionally, many components which are attached to the vehicle body are also made of steel so that they can be spot welded to the steel vehicle body.

There remains a significant and continuing need for improved connections between members of different metals, such as aluminum and steel, so that a vehicle body having an optimized cost of production and weight can be produced.

### SUMMARY OF THE INVENTION

The invention provides for a bi-metallic component including a first member of a first metal and a second member of a second metal different than the first metal. The first member defines at least one perforation. The second member is directly cast-in-place about a sheet-like portion of the first member and through the perforation to rigidly secure the first and second members.

The casting-in-place process involves the step of inserting a portion of the first member into a cavity of a mold and injecting the molten second metal into the cavity of the mold. The molten second metal will fill the cavity and the perforation of the first member. The molten second metal cools to form a solid second member which is rigidly secured to the first member through the perforations and through friction at the interface of the first and second members.

The first member can be a flat strip of sheet metal, or it can be shaped, for example through stamping or rolling. The first member can then be quickly and efficiently secured to the second member using the casting-in-place process with little to no additional manufacturing costs. Further, the resulting connection between the first and second members is very strong and can withstand forces as great as either of the first and second members could withstand individually. Where the first member is of steel and the second member is of aluminum or magnesium, the first member can then be spot welded to the remainder of the vehicle body. In other words, the bi-metallic component of the present invention can be used to in the manufacturing of a vehicle body including strategically located aluminum/magnesium and steel components. This is beneficial because it allows for a vehicle body with an optimized weight and cost of production without compromising the vehicle body's resistance to failure.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a top elevation view of a first exemplary embodiment of a bi-metallic component;

FIG. 2 is a cross-sectional view of the first exemplary embodiment of the bi-metallic component taken along line 2-2 of FIG. 1;

FIG. 3 is a top elevation view of a second exemplary embodiment of the first member of the bi-metallic component;

FIG. 4 is a top elevation view of a third exemplary embodiment of the first member of the bi-metallic component;

FIG. 5 is a top elevation view of a fourth exemplary embodiment of the bi-metallic component;

FIG. 6 is a cross-sectional view of the fourth exemplary embodiment of the bi-metallic component taken along line 6-6 of FIG. 5;

FIG. 7 is a top elevation view of a fifth exemplary embodiment of the bi-metallic component;

FIG. 8 is a top elevation view of a sixth exemplary embodiment of the bi-metallic component;

FIG. 9 is a perspective and elevation view of the top of an exemplary bi-metallic suspension control arm;

FIG. 10 is a perspective and elevation view of the bottom of the exemplary bi-metallic suspension arm;

FIG. 11 is a perspective and elevation view of the top of another exemplary bi-metallic suspension control arm;

FIG. 12 is a perspective and elevation view of the bottom of the other exemplary bi-metallic suspension control arm;

FIG. 13 is a perspective and elevation view of an exemplary bi-metallic body pillar node of a vehicle body;

FIG. 14 is a perspective and elevation view of an exemplary shock tower of a vehicle body; and

FIG. 15 is a flow chart of an exemplary method of forming a bi-metallic component.

### DETAILED DESCRIPTION OF THE ENABLING EMBODIMENTS

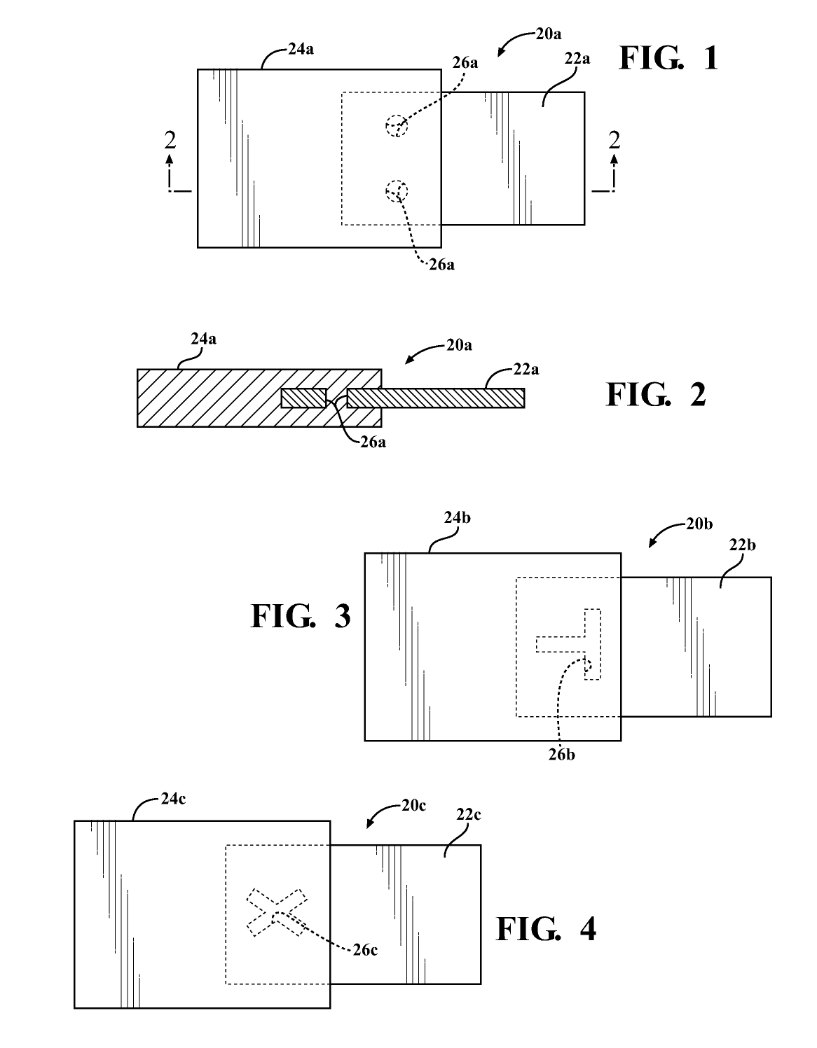

Referring to the Figures, wherein like numerals indicate corresponding parts throughout the several views, a bi-metallic component 20 is generally shown in FIGS. 1-14. The bi-metallic component 20 could be used in any application where fasteners, welds, or press fits are typically used for joining materials. In the exemplary embodiments, the bi-metallic component 20 is for various automobile components, such as those in a vehicle suspension, structure, body, or power train. For example, the bi-metallic component 20 could be an instrument panel support beam, a torsion beam axle, an engine mount, a sub-frame, a transmission pump, a drive shaft, a tubular seat component, an engine cradle cross-member, a radiator mount, a front end module, a bumper assembly, a steering column or a mounting bracket. However, it should be appreciated that the bi-metallic component 20 could be employed in a wide range of applications other than automobiles.

In each of the exemplary embodiments, the bi-metallic components 20 include a first member 22 of a first metal and a second member 24 of a second metal that is different than the first metal. The first metal is preferably a high strength steel, and the second metal is preferably aluminum, an aluminum alloy, or magnesium. However, it should be appreciated that the first and second metals could be any other types of metal. As will be discussed in further detail below, the second metal should have a melting point temperature that is lower than that of the first metal so that the second member 24 can be cast-in-place about a sheet-like portion of the first member 22 without damaging the first member 22. The sheet-like portion of the first member 22 could be flat, curved or it could include other features.

A first exemplary embodiment of the bi-metallic component 20a is generally shown in FIGS. 1 and 2. As can be seen, the first and second members 22a, 24a are secured to one another without any welds or any additional components, i.e. fasteners. Rather, the second member 24a is directly cast-in-place about a sheet-like portion of the first member 22a and through a pair of perforations 26a in the first member 22a. The cast-in-place process, which is described in further detail below, provides a very strong connection between the first and second members 22a, 24a.

The first member 22 could include any number of perforations 26, and those perforations 26 could take a wide variety of shapes. In the first exemplary embodiment, the perforations 26a extend entirely through the first member 22a, as best shown in FIG. 2. This allows for a portion of the second member 24a to extend through the perforations 26a, which more rigidly secures the second member 24a to the first member 22a. However, it should be appreciated that one or more of the perforations 26 could alternately extend only a fraction of the way through the first member 22. Additionally, the perforations 26 could be disposed on the sides of the first member 22.

If the bi-metallic component 20 is likely to be subjected to torque loads, it may be preferred to include either multiple perforations 26 spaced from one another or one (or more) non-circular perforation 26. Either of these configurations will provide additional reinforcement for resisting torsion forces between the first and second members 22, 24. For example, the first member 22a of the first exemplary embodiment of FIGS. 1 and 2 includes a pair of circular perforations 26a spaced from one another and extending through the first member 22a. As shown in FIG. 3, the first member 22b of the second exemplary embodiment of the bi-metallic component 20b includes a single, T-shaped (non-circular) perforation 26b, and the second member 24b is cast-in-place through this perforation 26b. As shown in FIG. 4, in the third exemplary embodiment of the bi-metallic component 20c, the first member 22c includes a single perforation 26c that is X-shaped (non-circular), and the second member 24c is cast-in-place through this perforation 26c. It should be appreciated that the perforations 26 could take a wide range of other shapes, including but not limited to a star shape, a hexagonal shape, or a square shape.

The perforations 26 can be formed into the first member 22 through a wide range of processes. For example, if the first member 22 is cast, then the casting mold (not shown) can include a predetermined number of projections extending across the mold cavity, around which the first molten metal solidifies to form the perforations 26 in the first member 22. Alternately, the first member 22 could be a shaped or unshaped strip of sheet metal, and the perforations 26 could be punched or machined out of the first member 22. It should be appreciated that the first member 22 and the perforations 26 could be formed using any desirable process.

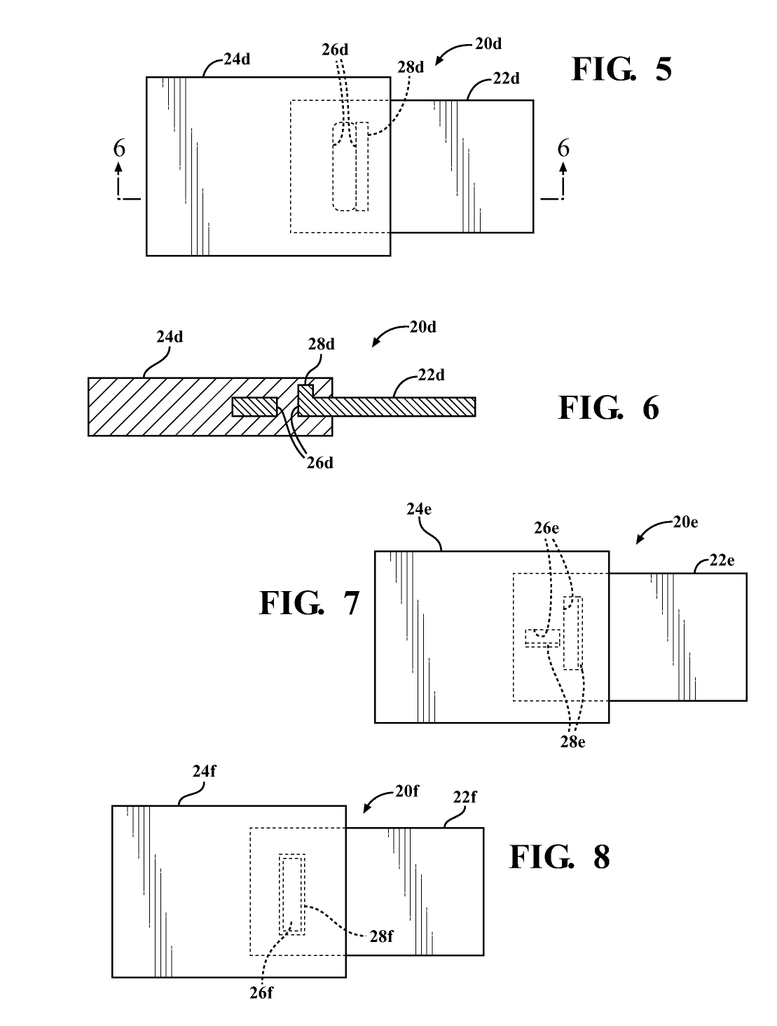

The perforations 26 could also be formed by cutting or punching a slit in the first member 22 and bending the first metal on one or more sides of the slit. For example, the fourth exemplary embodiment of the bi-metallic component 20d is shown in FIGS. 5 and 6 and includes a single, rectangular perforation 26d which was formed in the first member 22d with this process. As best shown in FIG. 6, the bending process creates a flange 28d extending generally perpendicularly away from the top surface of the first member 22d. The flange 28d is beneficial because it increases the surface area of the interface of the first and second members 22d, 24d and because it provides additional reinforcement to prevent the second member 24d from disconnecting from the first member 22d. Additionally, forming the perforation 26d by bending the material is advantageous because it reduces waste, i.e. more of the material of the first member 22d is used advantageously to rigidly secure the first and second members 22d, 24d together.

The first member 22 could also include more than one perforation 26 formed using the slit and bending process. For example, the fifth exemplary embodiment of the bi-metallic component 20e is generally shown in FIG. 7 and includes a pair of perforations 26e and flanges 28e arranged perpendicularly to one another in the first member 22e. The second member 24e is cast-in-place through these perforations 26e. Even further, as shown in the sixth exemplary embodiment of the bi-metallic component 20f of FIG. 8, the first metal of the first member 22f could be bent in multiple directions away from the slit. In the sixth exemplary embodiment, the first member 22f includes a flange 28f encircling the perforation 26f. Like the other embodiments, the second member 24f is cast-in-place through the perforation 26f.

In the first six exemplary embodiments, the first member 22 is a rectangular and flat strip of sheet metal. This is particularly advantageous in applications where the second member 24 is of aluminum and must be attached to a steel structure, e.g. the body of a vehicle. In such an application, the first member 22 can be of steel, which can be quickly and cheaply spot welded to the steel structure. Thus, the bi-metallic component 20 including the second member 26 of aluminum can be rigidly secured to the steel structure without any additional fasteners or brazing materials.

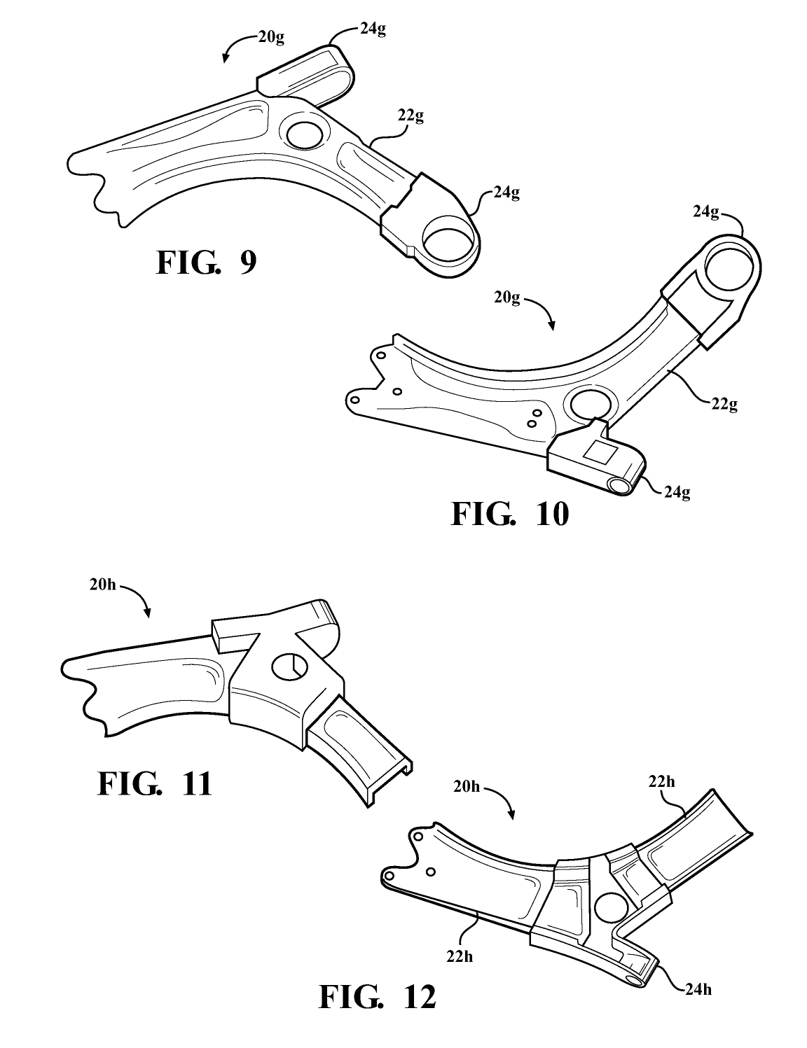

It should be appreciated that the bi-metallic component 20 could take many other shapes. For example, in FIGS. 9 and 10, the bi-metallic component 20g is a support arm 20g for a vehicle suspension. The first member 22g of the bi-metallic support arm 20g is a sheet-like steel bracket 22g of a suspension control arm including a plurality of grooves and other features for providing additional stiffness to the bracket 22g.

The bi-metallic component 20 could include more than one second member 24 attached to a single first member 22. For example, the bi-metallic support arm 20g of FIGS. 9 and 10 includes a pair of second members 24g, each of which is an aluminum mount 24g for attachment to a vehicle suspension component (not shown). The mounts 24g are interconnected with one another through the bracket 22g.

Further, the bi-metallic component 20 could include more than one first member 22 attached to a single second member 24. For example, FIGS. 11 and 12 show another bi-metallic support arm 20h for a vehicle suspension. In this bi-metallic support arm 20h, the second member 24h is an aluminum mount 24h and the first members 22h are sheet-like, steel brackets 22h extending outwardly from the aluminum mount 24h. In this embodiment, the aluminum mount 24h is cast-in-place about a portion of each of the steel brackets 22h.

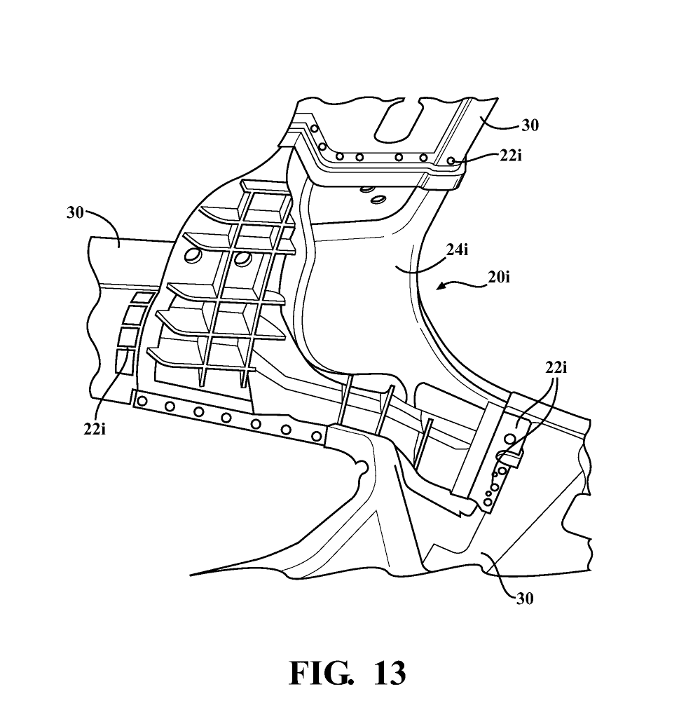

In FIG. 13, the bi-metallic component 20i is a vehicle body pillar node 20i. In this embodiment, the second member 24i is of aluminum, and four first members 22i of steel are secured to the second member 24i through the cast-in-place process described above. In the exemplary embodiment of FIG. 13, the first members 22i are spot welded to a vehicle body 30 of steel. This is advantageous because the overall weight of the vehicle body 30 is reduced because the vehicle body pillar node 20i is partially of aluminum rather than entirely of steel. The aluminum is strategically placed in the vehicle body 30 to optimize the vehicle's weight and cost of manufacturing without compromising the vehicle body's 30 resistance to failure.

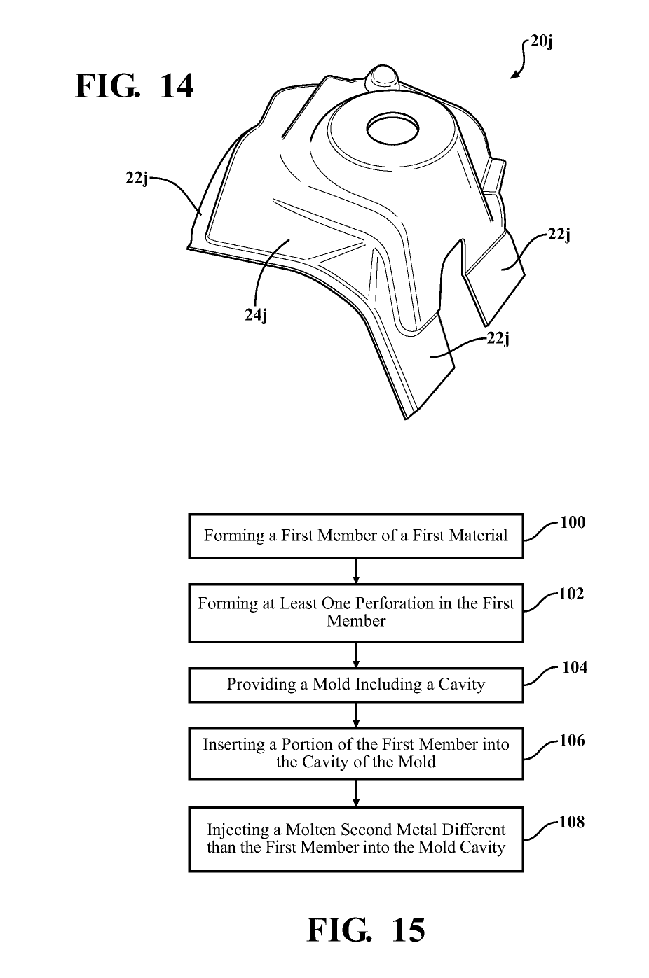

In FIG. 14, the bi-metallic component 20j is a bi-metallic vehicle shock tower 20j. In this embodiment, the second member 24j is of aluminum, and three first members 22j of steel are secured to the second member 24j through the cast-in-place process described above. The first members 22j may be spot welded to a vehicle body (not shown). This is advantageous because the overall weight of the vehicle is reduced because the vehicle shock tower 20j is partially of aluminum rather than entirely of steel.

An exemplary method of forming a bi-metallic component 20 is shown in the flow chart of FIG. 15. The method starts with the step 100 of forming a first member 22 of a first metal. As explained above, in the exemplary embodiments, the first metal is a high strength steel. The first member 22 could be formed using any desirable forming process, including, for example, casting, rolling, stamping, machining, etc. Alternately, the first member 22 could be a strip of sheet metal.

The method continues with the step 102 of forming at least one perforation 26 in the first member 22. Preferably, each of the perforations 26 extends through the first member 22. However, it should be appreciated that the perforations 26 could extend partly through the first member 22. The perforations 26 could be formed during or after the forming of the first member 22. As explained above, the first member 22 could have any number of perorations 26, and the perforations 26 could take any desirable shape.

The method continues with the step 104 of providing a mold including a cavity. Any desirable casting processes can be used to form the second member 24, and therefore, the mold could be a metal die, a ceramic mold, a sand mold, etc. Additionally, pressure squeeze or vacuum casting could be employed in the casting process.

The method then continues with the step 106 inserting a portion of the first member 22 into the cavity of the mold. At least one of the perforations 26 should be included in the portion of the first member 22 inserted into the mold. Next, the method continues with the step 108 of injecting a molten second metal different than the first metal of the first member 22 into the cavity containing the portion of the first member 22. The molten second metal fills the cavity in the mold and enrobes the portion of the first member 22 including the perforations 26 of the first member 22. The second metal should have a melting point temperature that is less than the melting point temperature of the first metal, and the molten second metal should be injected into the cavity of the mold at a temperature that is greater than the melting point temperature of the second metal but less than the melting point temperature of the first metal. This ensures that the first member 22 is not damaged during the casting process. As discussed above, the first metal is preferably a high strength steel, and the second metal is preferably aluminum. The molten aluminum is preferably injected into the cavity of the mold at a temperature of approximately six hundred and twenty to seven hundred and sixty degrees Celsius (620-760° C.).

Once the second metal cools and solidifies, the mold can be opened to present a second member 24 rigidly secured to the first member 22 both through friction at the interfacing surfaces of the first and second members 22, 24 and through the portions of the second member 24 extending through the perforations 26 of the first member 22. The resulting connection between the first and second members 22, 24 is very strong and does not require additional fasteners or other components. If desired, the bi-metallic component 20 can also undergo a heat treating process to alter the physical properties of the first and/or second metals.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

What is claimed is:

1. A bi-metallic component comprising:
a first member of a first metal;
said first member being sheet-like and defining at least one perforation extending therethrough, the perforation formed by slicing and bending the first metal; and
a second member of a second metal different than said first metal and being directly cast-in-place about a portion of said first member and through said perforation to rigidly secure said first and second members.

2. The bi-metallic component as set forth in claim 1 wherein said second metal has a melting point temperature of less than said first metal.

3. The bi-metallic component as set forth in claim 1 wherein said first metal is steel.

4. The bi-metallic component as set forth in claim 3 wherein said first member is formed of sheet metal.

5. The bi-metallic component as set forth in claim 3 wherein the second metal is an aluminum.

6. The bi-metallic component as set forth in claim 1 wherein in said at least one perforation is further defined as a plurality of perforations.

7. The bi-metallic component as set forth in claim 1 wherein said at least one perforation is non-circular.

8. The bi-metallic component as set forth in claim 1 wherein said at least one perforation is circular.

9. The bi-metallic component as set forth in claim 1 wherein said first and second members are components of an automobile.

10. The bi-metallic component as set forth in claim 1 wherein said first member is a bracket and said second member is a suspension mount.

11. The bi-metallic component as set forth in claim 1 wherein said first member further includes a flange adjacent said perforation.

12. A method of producing a bi-metallic component, comprising the steps of:
forming a first member of a first metal;
forming at least one perforation in a sheet-like portion of the first member with the perforation extending through the first member by slicing and bending the first metal; and
casting a second member of a second metal different than the first metal onto a portion of the first member and through the perforation to rigidly secure the first and second members.

13. The method as set forth in claim 12 wherein the first metal is steel.

14. The method as set forth in claim 13 wherein the second metal is an aluminum.

15. The method as set forth in claim 12 wherein the first metal has a melting point temperature that is greater than the melting point temperature of the second metal.

16. The method as set forth in claim 15 wherein said step of casting the second member onto a portion of the first member further includes the steps of:
providing a mold including a cavity;
inserting a portion of the first member into the cavity of the mold; and
injecting a molten second metal into the cavity of the mold.

17. The method as set forth in claim 16 wherein the molten second metal in said injecting step is at a temperature greater than the melting point temperature of the second metal and less than the melting point temperature of the first metal.

18. The method as set forth in claim 17 wherein the molten second metal is at a temperature in the range of six hundred and twenty to seven hundred and sixty degrees Celsius (620-760° C.).

19. The method as set forth in claim 12 further including the step of welding the first member to a steel structure.

20. A vehicle body comprising:
a steel component;
a bi-metallic component including a first member of steel and a second member of aluminum;
said first member being sheet-like and defining at least one perforation extending therethrough;
said second member being of aluminum and being directly cast-in-place about a portion of said first member and through said perforation to rigidly secure said first and second components; and
said steel component being welded to said steel first member of said bi-metallic component.
